(19) United States
(12) Patent Application Publication
(10) Pub. No.: US 2024/0330993 A1
(43) Pub. Date: Oct. 3, 2024

(54) METHOD AND SYSTEM FOR REALTIME MEASURING OF PRODUCT REPUTATION

(71) Applicant: ELM, Riyadh (SA)

(72) Inventors: Muhammad Saleh Saeed AL-QURISHI, Riyadh (SA); Sarah AL-QASEEMI, Riyadh (SA); Riad SOUISSI, Riyadh (SA)

(73) Assignee: ELM, Riyadh (SA)

(21) Appl. No.: 18/488,488

(22) Filed: Oct. 17, 2023

Related U.S. Application Data
(60) Provisional application No. 63/455,445, filed on Mar. 29, 2023.

(51) Int. Cl. G06Q 30/0282; G06F 40/20

(52) U.S. Cl. CPC G06Q 30/0282; G06F 40/20

(57) ABSTRACT

A system and method measures in real time the reputation of products or services based on customer reviews and social media mentions. The method includes cyclically refining a search to collect, using a natural language processing (NLP) model, data relating to the products or services, and simultaneously recognizing product/service aspects and classifying sentiment for the collected data, using a single multi-task machine learning model.

### CROSS-REFERENCE TO RELATED APPLICATIONS

This application claims the benefit of priority to provisional application No. 63/455,445 filed Mar. 29, 2023, the entire contents of which are incorporated herein by reference.

### BACKGROUND

### Technical Field

The present disclosure is directed to an apparatus and a method for real-time measuring of product/service reputation from open web data (e.g., reviews, comments, tweets, and posts). The apparatus performs data collection, control, editing and visualizing, in order to answer inquiries regarding reputation of any product/service described in the open-web.

### Description of Related Art

Measuring product/service reputation is an essential task for businesses and organizations to understand how their products/services are perceived by the public. A product's/service's reputation can have a significant impact on its sales, customer loyalty, and brand image. Companies have relied on surveys and focus groups to collect feedback from customers. However, with the advent of the internet and social media, there is now a wealth of public opinion available on the open-web that can be used to measure product/service reputation.

There are several methods used to measure product/service reputation from collected public opinion. One popular method for measuring product reputation is sentiment analysis, which involves using natural language processing (NLP) techniques to analyze the tone and sentiment of customer feedback. Sentiment analysis can be performed on various forms of customer feedback, including social media posts, product reviews, and customer support tickets. The sentiment analysis process involves using machine learning algorithms to classify feedback as positive, negative, or neutral, based on the language used in the feedback.

Another approach to measuring product/service reputation is using social listening tools. Social listening tools allow companies to monitor social media platforms for mentions of their brand or products. These tools can collect data from various sources, including social media platforms, news articles, and blogs. By analyzing the data collected, companies can gain insights into customer sentiment towards their products/services, identify trends, and track how their brand is being perceived over time.

In addition to sentiment analysis and social listening, companies can also use online surveys to collect feedback from customers. Online surveys are a common method for collecting feedback as they can be easily distributed to a large number of customers and can be completed quickly. Surveys can be designed to gather information about specific aspects of a product/service, such as its quality, functionality, and design. However, surveys can be limited in their ability to capture the nuances of customer sentiment and may not be representative of the broader population.

While these methods have proven effective in measuring product reputation, there are also challenges associated with using public opinion from the open-web to evaluate product/service reputation. One challenge is the sheer volume of data that is available. Companies need to be able to process and analyze large amounts of data to gain meaningful insights. It can be difficult to know how much data to collect and which data is relevant to the research question. This challenge can be addressed by using search filters to narrow down the results to specific keywords or topics. Additionally, tools like web scrapers can be used to automate the collection of data, which can save time and ensure that a sufficient amount of data is collected.

Another challenge is the noise in the data. Social media platforms are known for their unstructured and informal nature, which can lead to a lot of noise in the data. This noise can take many forms, such as irrelevant posts, spam, or posts that are sarcastic or ironic. To address this challenge, researchers can use natural language processing (NLP) techniques to filter out irrelevant posts and to identify sentiment and other relevant information. For example, NLP techniques such as part-of-speech tagging and named entity recognition can be used to identify relevant keywords and topics in the data.

Another challenge is the need to ensure the quality and accuracy of the data. This can be done by using multiple sources of data and by cross-checking the results to ensure consistency. Additionally, researchers can use crowdsourcing platforms to verify the accuracy of the data and to identify any errors or inconsistencies. Further challenge is the potential for bias in public opinion. Customers who leave feedback online may not be representative of the broader population and may have different opinions than customers who do not leave feedback. Furthermore, the sentiment expressed in feedback may not be a true reflection of the customer's actual experience with the product. Customers may be more likely to leave feedback when they have had an extreme positive or negative experience, which can skew the overall sentiment analysis results.

Despite these challenges, one object of the present disclosure is the use of the open web as a source of public opinion data for measuring product/service reputation. The present disclosure includes a description of methods and systems, e.g., tools and techniques, to extract meaningful insights from the public opinion data. Particular aspects of the present disclosure include methods and systems capable of providing a more comprehensive, accurate, and cost-effective strategy and understanding to measure product/service reputation based on public opinion including providing accurate and reliable data by filtering out noise to ensure that the data is relevant and accurate.

### SUMMARY

An aspect of the present disclosure is a method for measuring the reputation of products or services based on customer reviews and social media mentions, the method can include cyclically refining a search to collect, using a natural language processing (NLP) model via processing circuitry, data relating to the products or services; and simultaneously recognizing product/service aspects and classifying sentiment for the collected data, using a single multi-task machine learning model via the processing circuitry, in which the product/service aspects are features and characteristics of a product or service that impact a sentiment class.

A further aspect of the present disclosure is a system for measuring the reputation of products or services based on customer reviews and social media mentions, the system can include processing circuitry configured with a natural language processing (NLP) model for cyclically refining a search to collect data relating to the products or services; and a single multi-task machine learning model for simultaneously recognizing product or service aspects and classifying sentiment for the collected data, in which the product/service aspects are features and characteristics of a product or service that impact a sentiment class.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 illustrates a system architecture, in accordance with an exemplary aspect of the disclosure;

FIG. 2 is flowchart of a data acquisition process, in accordance with an exemplary aspect of the disclosure;

FIG. 3 is a flowchart of a transformer-based query evolving process, in accordance with an exemplary aspect of the disclosure;

FIG. 4 is a flow diagram for a words-aspects similarity measure, in accordance with an exemplary aspect of the disclosure;

FIG. 5 is an algorithm for a multi-task model architecture, in accordance with an exemplary aspect of the disclosure;

FIG. 6 is flow diagram for the multi-task model architecture, in accordance with an exemplary aspect of the disclosure;

FIG. 7 is a flowchart for modeling and prediction of an aspect class, in accordance with an exemplary aspect of the disclosure;

FIG. 8 is an algorithm for training a multi-task model, in accordance with an exemplary aspect of the disclosure;

FIG. 9 is a flowchart of aspect sentiment inference, in accordance with an exemplary aspect of the disclosure;

FIG. 10 is a flowchart for a process of building the attention matrix to extract similar aspects, in accordance with an exemplary aspect of the disclosure;

FIG. 11 is a display for a user interface for entering a search, in accordance with an exemplary aspect of the disclosure;

FIG. 12 is a display of search results for the search of FIG. 11, in accordance with an exemplary aspect of the disclosure;

FIG. 13 is a display for a user interface to start an analysis, in accordance with an exemplary aspect of the disclosure;

FIG. 14 is a display for analysis results from one aspect, in accordance with an exemplary aspect of the disclosure;

FIG. 15 is a display for analysis results from another aspect, in accordance with an exemplary aspect of the disclosure;

FIG. 16 is a display for comparing a specific product to another product, in accordance with an exemplary aspect of the disclosure;

FIG. 17 is a display for comparing a specific product to an alternative product, in accordance with an exemplary aspect of the disclosure;

FIG. 18 is an illustration of a non-limiting example of details of computing hardware used in the computing system, according to aspects of the present disclosure;

FIG. 19 is an exemplary schematic diagram of a data processing system used within the computing system, according to aspects of the present disclosure;

FIG. 20 is an exemplary schematic diagram of a processor used with the computing system, according to aspects of the present disclosure; and

FIG. 21 is an illustration of a non-limiting example of distributed components that may share processing with the controller, according to aspects of the present disclosure.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise. The drawings are generally drawn to scale unless specified otherwise or illustrating schematic structures or flowcharts.

Furthermore, the terms “approximately,” “approximate,” “about,” and similar terms generally refer to ranges that include the identified value within a margin of 20%, 10%, or preferably 5%, and any values therebetween.

The present disclosure relates to a system that can help a user decide on acquiring a particular product/service based on several extracted features from the collected comments and reviews from the open web. The comments and reviews are collected from multiple sources, including social networks such as Facebook, Twitter, YouTube, Reddit, and various blogs, as well as e-commerce sites such as Noon, Alibaba, and Amazon, and others, and users can use the system to benefit from the different analysis and data mining processes to have a better insight to decide about acquiring a product or subscribing to a particular service. In addition, the user can compare any product/service to any other competitor's product/service. By typing the product or brand name and selecting the data source, for example, twitter, Facebook or e-commerce website, the system will interact with the user to obtain the aspects that the user is interested in, and with data that has been labeled using a few shots trained model, the system will be able to search for the relevant comments and reviews, then remove the irrelevant comments. The system uses two AI-based models to analyze and mine the reviews and comments in the sources (?). The first AI-based model includes a transformer-based neural network architecture that recognizes product/service aspects from the collected textual data (reviews, comments and tweets). The second AI-based model receives the extracted sentences based on the product/service aspects and detects the sentiment of each sentence in the collected textual data with respect to the recognized aspects. In the middle, the system includes a sentence segmentation algorithm. The sentence segmentation algorithm is important especially for Arabic language content.

In a preferred embodiment, a graphics processor and a general purpose processor are in communication with a memory and are operative to execute all system machine learning models.

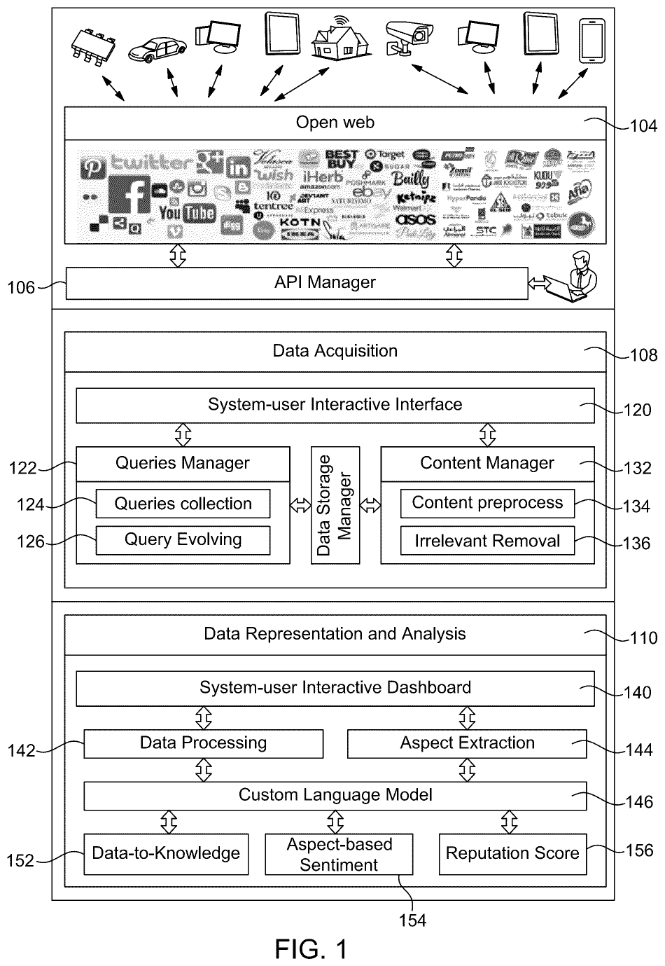

FIG. 1 illustrates a system architecture for measuring product reputation. The system 100 includes layers as shown in FIG. 1, that facilitate simple scaling and upgrading to fit the user needs. The layers include a data acquisition layer 108 and a data representation and analysis layer 110. The system 100 also includes an API manager 106. The data acquisition layer 108 includes a queries manager 122, and content manager 132 configured to provide coordination and control functions.

The queries manager 122 includes a queries collection function 124 that collects queries, and a query evolving function 126 that expands the queries. The content manager 132 includes a content preprocess function 134, and an irrelevant content removal function 136. The queries manager 122 and the content manager 132 store and retrieve queries and content by way of a data storage manager 128.

Throughout this disclosure, aspect extraction and aspect recognition are used interchangeably. Both aspect extraction and aspect recognition relate to recognizing aspect terms in textual content.

The data representation and analysis layer 110 includes a system-user interactive dashboard 140, that is supported by a data processing function 142 and an aspect extraction function 144. The data processing function 142 and aspect extraction function 144 work with a custom language model 146. The custom language model 146 accommodates a data-to-knowledge function 152, an aspect-based sentiment function 154, a reputation score function 156.

The system 100 gives the user good insight about a particular product or service so that the user can easily make an appropriate decision to meet his/her needs. This disclosure presents an apparatus and a method for near real-time measuring of product/service reputation from open web data 104 (including review, comments, tweets, and post). The role of the system 100 is to perform data collection, control, editing and visualizing, thus answering inquiries regarding reputation of any product/service described in the open-web 104. These diverse features are realized through four separate modules, which are mutually related in an algorithmic manner, with every module having direct communication with every other module along with an outlet to the knowledgebase.

The four modules that constitute the complete system architecture of System 100 are as follows:

### 1. Source of the Data Module:

This module serves as the starting point of the system, where all raw data is sourced. It includes social media platforms and open web sources such as reviews, comments, tweets, and posts.

### 2. API Manager Module:

This module acts as the gateway for the system to interact with the external data sources. It manages the APIs that are used to access and pull data from various platforms.

### 3. Data Acquisition Module:

This module is responsible for the handling and initial processing of the data fetched through the API Manager Module.

Sub-components: Query Manager and Content Manager.

### 4. Data Representation and Analysis Module:

This is the core analytical engine of the system. It processes the data acquired by the Data Acquisition Module to generate insights, visualize the information, and enable user interaction.

Sub-components: System-User Interactive Dashboard, Aspect Recognition and Extraction Model, Custom Language Model, Data-to-Knowledge Algorithm, Aspect-Based Sentiment Analysis Models, and Reputation Score Algorithm

### Data Acquisition Module

A system-user interactive interface 120 is a first component encountered by the user and serves to set up the user profile and setup the themes to be included in the search process, validating the parameters, initializing the algorithm and finally running the procedure of data collection, with real time updates on its current progression. The system-user interface 120 of the system allows users to enter specific keywords and monitor the data collection process as it unfolds.

A separate API Manager 106 is configured to establish a connection with open web platforms 104 on a technical level. Functions of the API Manager 106 include formulating and executing precise requests to the platforms 104, and coordinating the incoming and outgoing streams of data.

The content manager 132 is configured to process and classify the data returned from the API Manager 106 and sort the data based on its relatedness to the subject of the request. At the same time, the Queries Manager 122 is configured to build the queries collection 124, implement the evolving algorithm 126 that depends on the relatedness scores that come from the content manager 132 and finally send the queries in a batch to the API Manager 106.

The information harvested from the selected platforms reach the Data Storage Manager 128, which transforms it into a format that can be easily stored in internal memory of the system 100. The Data Storage Manager 128 tool is connected to the Data Representation and Analysis layer 110, and this connection is used to update the data in a database when needed.

There are many sources from which people's opinions and reviews can be collected about a particular service or product. Among these sources are electronic stores such as Noon, Alibaba, Amazon, and others. However, this type of data may not be sufficient and may not always be available to conduct analysis and cannot be utilized to give a deep insight to the user to make a decision.

To collect a sufficient number of reviews and opinions, social networks such as Facebook, Twitter, YouTube, and may be a better option for data collection. Social media involves social networks or social networking. Social media are forms of electronic communication (such as websites for social networking and microblogging) through which users create online communities to share information, ideas, personal messages, and other content (such as videos). However, there are two main problems with collecting reviews and opinions from social networks: the first problem is the inability to know the amount of data that may be found in a particular search. The other problem is that these data are very noisy, and may contain much repetition, as well as posts that are irrelevant to the subject of the research for a particular service or product.

Whenever a certain subject is searched on a selected electronic store or social media platform, the results show the total number of retrieved posts that refer to the search. This total number is estimated through specific formulas for specific electronic stores or social media platforms that integrate multiple indicators of semantic connections

There is a specific challenge in data acquisition from platforms like Twitter or YouTube, where the initial number of results shown is often much larger than the number of results that can be realistically browsed through or retrieved via the API. The present disclosure provides a solution in the form of a “query evolution based recursive data acquisition approach” to attempt to retrieve a significant portion of available content, despite these restrictions.

### Discrepancy in Reported and Accessible Data:

In a practical scenario, consider a search on platforms like YouTube or Twitter for comments or tweets related to a recent product launch, say “Smartphone X”. Initially, Twitter might display that there are approximately 200,000 tweets related to “Smartphone X”. However, as a user navigates deeper into the results, beyond the 50th page where each page contains 10 tweets, this number might abruptly drop to a few thousand.

This indicates a known issue: the actual volume of accessible data related to a search query isn't transparent to end-users. The public API services of platforms like Twitter further enforce stringent limits on data retrieval.

### Implications of Incomplete Sampling:

Under these conditions, retrieving only a truncated subset of the data, which we'll term “shallow sampling”, could lead to skewed insights. For example, shallow sampling might disproportionately represent only the most recent or the most popular opinions about “Smartphone X”, potentially ignoring valuable but less prominent data.

### Solution: Iterative Query Refinement and Data Augmentation Approach:

To address this limitation, we propose an ‘Iterative Query Refinement and Data Augmentation Approach’. This means that our system doesn't rely on a single, static query to collect data. Instead, it begins with an initial broad query, like “Smartphone X reviews”.

As data is collected and analyzed, the system identifies key themes, trends, or gaps in the data—for instance, that there are many comments about the phone's camera quality but few about its battery life. The system then autonomously refines its query to be more targeted, such as “Smartphone X battery life reviews”.

This process is repeated in a recursive manner, allowing the system to ‘navigate’ through the constraints imposed by the data provider's API, progressively ‘deepening’ the dataset with each iteration.

This strategic approach is devised to optimize the quantity and diversity of data we can acquire for analysis, despite platform-imposed limitations. It is designed to enable more comprehensive, accurate, and reliable visualizations and topic analyses.

### Example of Adjusting Tolerance in Queries:

Additionally, our system allows for adjusting the ‘tolerance’ level of queries. For example, with a ‘high-tolerance’ setting, a search for “Smartphone X camera quality” might also retrieve posts discussing “Smartphone X photo features”. With ‘low-tolerance’, the search would be more stringent and specific, focusing narrowly on exact matches.

For example, in a case of a selected topic of cars, this number (N) has been determined to be close to 1.5M posts. Reliability of the parameter N is unconfirmed, since browsing forward quickly brings its value down, even if the number of results listed on previous pages is too small to account for the difference. The same trend exists for other subjects as well and is not isolated to a selected topic. Because of this, it can be concluded that the actual count of related posts can't be determined on the selected platform due to limitations set by its own API that prevents displaying results ad infinitum. These same limitations also delineate the amount of metadata that can be gathered from the platform. At the same time, any research that would be based only on a portion of the true sample could be seriously compromised. To solve these issues, the method and system of the present disclosure use cyclical methodology that performs a gradual enhancement of the data gathering module, thus enabling access to a full range of related posts.

### Data Acquisition Process

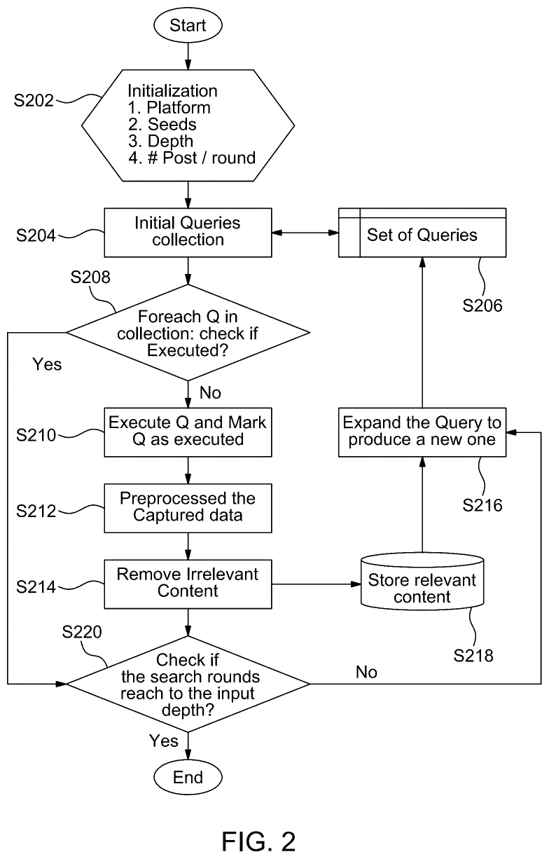

FIG. 2 is flowchart of a data acquisition process that exhibits the cyclical methodology. The data acquisition process is a process performed in the data acquisition layer 108. The data acquisition layer 108 includes the content manager 132, the queries manager 122, and the data storage manager 128. The content manager 132 performs the content preprocess function 134 and the irrelevant content removal function 136. The queries manager 122 performs the queries collection function 124 and the query evolving function 126.

During the data acquisition process, two operations are used: removing, by the irrelevant content removal function 136, the posts that don't match the relevance degree demanded by the user; and refining the collection mechanism, by introducing new aspects and keywords using the query evolving function 126. For purposes of this disclosure, an ‘aspect’ is defined as a specific attribute or feature of a product or service that users may express opinions or feelings about in their online posts. Aspects can be tangible or intangible characteristics and can vary widely depending on the product or service in question. Examples of aspects for a smartphone might include battery life, camera quality, screen size, user interface, and price. For a restaurant, aspects might include food quality, service speed, ambiance, and cleanliness.

### Content Set:

The content set is a collection of data points, derived from the raw data fetched from open web sources, that are relevant to the analysis. For each post in the content set, we might store: The text of the post (review, comment, tweet, etc.)

Metadata such as the source, author, and timestamp of the post

Calculated values such as sentiment scores for different aspects mentioned in the post

Flags or tags indicating whether the post was deemed relevant based on the user's criteria, as determined by the irrelevant content removal function 136.

### Search Query Set:

The search query set is a collection of search queries that the system uses to fetch data from the open web. Each search query in this set is designed to find posts related to a specific aspect or set of aspects of the product or service under analysis, as well as general posts related to the product or service as a whole. This set includes:

Keywords: These are specific terms or phrases that the system searches for. They might include the name of the product or service, common abbreviations, and synonyms.

Aspects: In addition to general keywords related to the product or service, the search queries also explicitly look for mentions of specific aspects. For a smartphone, queries might be constructed to find posts specifically mentioning the “battery life” or “camera quality” of the phone.

Operators/Modifiers: These are additional terms or symbols used in the search queries to refine the results. For example, operators might be used to exclude posts containing certain words, to require exact phrase matches, or to search within a certain date range.

The data acquisition process is carefully planned, and it starts with, step S202, an initialization process to select the target platform/s, seeds, and a depth, along with preparing two sets of words and phrases, one for content and the other for search queries. These sets are then used to perpetuate cyclical searching, as well as the gradual improvement of the search algorithm and data storage.

### Removing the Irrelevant Content

In step S204, the data acquisition process uses an initial queries collection. For purposes of this disclosure, a query is a set of keywords including product/service aspects. In step S208, a decision is made to determine for each query Q in the collection, if the query is executed. If not (NO in S208), in S210, the query Q is executed and marked as being executed. In S212, the data captured using the query Q is preprocessed to format the data for analysis.

In step S214, content that doesn't have a realistic relation to the searched topic can be eliminated from further analysis with two degrees of tolerance. If low level of tolerance is applied, only those posts that match every keyword in its proper place will be displayed, while with higher tolerance some of the results may be only partial matches. Regardless of the selected tolerance level, the retrieved content will be compared to see how much the non-conforming keywords fit with the rest of the content. Their score on this aspect is taken into final calculation whether to keep the post/tweet in S218 among the results or not.

To use a practical example, if a search is made for keywords 2010 Camry, then with a low-tolerance setting any posts referring to other songs by the same author would not be included. Conversely, these items would be included in the high-tolerance scenario because the theme would have a relevant semantic connection with words most commonly used to describe the selected post.

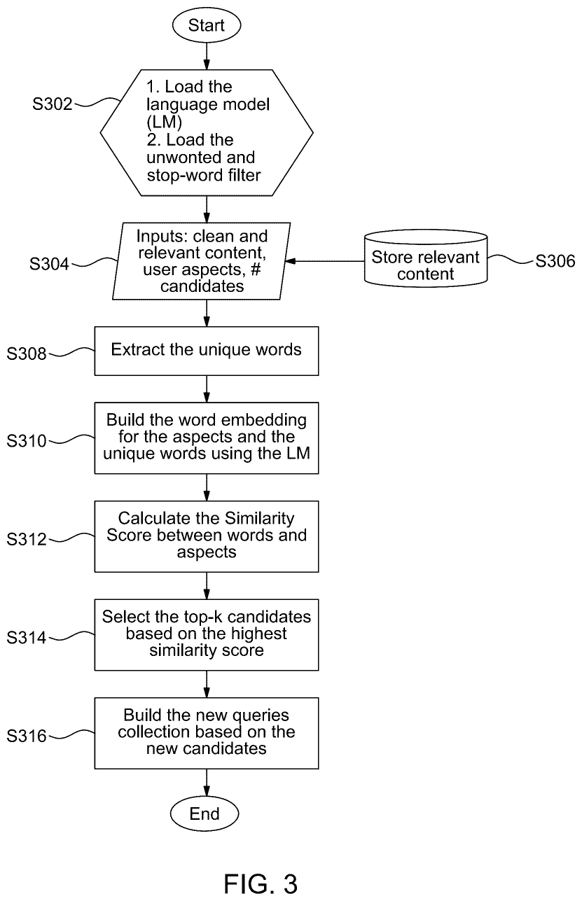

The initial search queries are optimized by the user through inclusion of the initial seeds which contain one or more keywords plus the required aspects of the product or the service. Every request can return up to one thousand posts during its first search round. Following the completion of the initial cycle, a phase of query refinement will commence. In this phase, in step S216, new queries are formulated using the Transformer-based Query Expansion algorithm (FIG. 3). In every new cycle, K-most intensively used keywords are added to the original search query, and in the next iteration only the results for the updated request are saved. The described data acquisition process continues to cycle until, in step S220, no more unique results can be extracted or a depth parameter is met that was initially entered by the user.

### Transformer-Based Query Expansion

FIG. 3 is a flowchart of a transformer-based query evolving process. The transformer-based query evolving process is carried out using the irrelevant content removal function 136. In S216, the query can be expanded to, in S206, produce a new query to produce a new set of queries. New queries can be built using a language model, in particular, a model that is in the form of a transformer network.

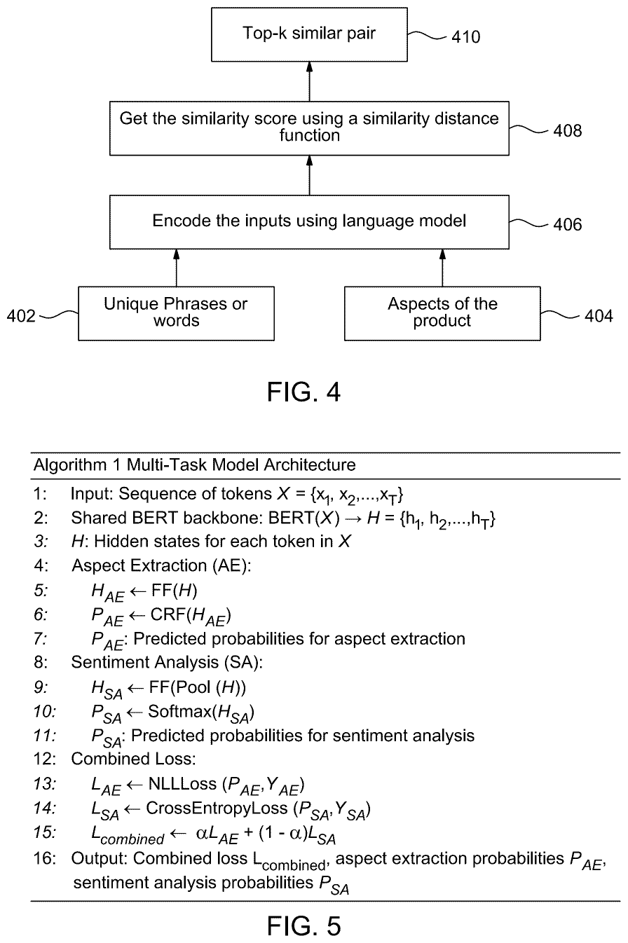

As illustrated in FIG. 3, queries can be expanded using a pretrained language model (LM). The expansion of queries is performed using the query evolving function 126 of the queries manager 122. In step S302, a language model and an unwanted and stop word filter are loaded into the system 100. In S304, inputs include clean and relevant content-obtained from a relevant content storage S306, user aspects and a number of candidates. In step S308, the unique words/phrases are extracted from the first sample of the inputted data. Next, in step S310, both the aspects entered by the user and the extracted unique words/phrases are encoded using the pretrained language model in order to get embedding vectors. Then, in step S312, a measuring distance function (such as Euclidean, Cosine, Dice, Jaccard etc.) can be used to get the similarity score between the words-aspects embedded vectors, as shown in FIG. 4.

FIG. 4 is a flow diagram for a words-aspects similarity measure. The words-aspects similarity measure is performed using the queries collection function 124 of the queries manager 122. Unique phrases or words are input in 402. User aspects of a product/service are input in 404. In 406, the inputs are encoded into embedded vectors using a language model. In 408, a similarity score between pairs of embedded vectors is determined using a similarity distance function. In 410, the similar pairs of vectors are output.

In step S314, the results of the words-aspects similarity measure are sorted to get the top K similar pairs, where K is the number of candidates to be used. In S316, a new queries collection is built based on the K candidates.

Data are a main pillar for the success of artificial intelligence models, and therefore when it is well available and organized, this enhances the production of robust models with high and reliable inference accuracy. So, after completing this procedure, the data is now available in the required form and ready to be worked on. The work is performed from three directions (see data-to-knowledge function 152, aspect-based sentiment function 154, and reputation score function 156): First, the work of a custom language model 146, in the aspect-based sentiment function 154, is able to extract the aspects that people need to know about a specific service/product and analyze their sentiment based on these aspects. For example, in a cars example, one of the aspects that people need to know is fuel consumption or a car's suitability for the family, and so on. Second, the analysis converts data into knowledge, in the data-to-knowledge function 152, by showing some insight from the data. Finally, the searched products/service are ranked, in the reputation score function 156, with respect to the preferences and opinion on the aspects.

### Data Representation and Analysis Layer

In the Data Representation and Analysis layer 110 of the system, there are several modules and processes that can be used in order to deal with the collected data and display it in a manner commensurate with the need of the end user. One solution to determining and displaying data that is commensurate with the need of the user is to actively seek relevant information in any of the dimensions of the data sample that could be taken as illustrative of general behavior on the network. This information can be presented in a graphically attractive format that can be helpful to users attempting to formulate working applications based on perceived tendencies. Once all preparatory procedures with input parameters are completed, the system facilitates display of a number of visual charts suitable for a broad range of analytic applications.

### Multitask Model for Aspect Extraction and Sentiment Tasks

The following is a description of an artificial intelligence (AI) model created to recognize the aspect in the collected and relevant post.

### Model Architecture

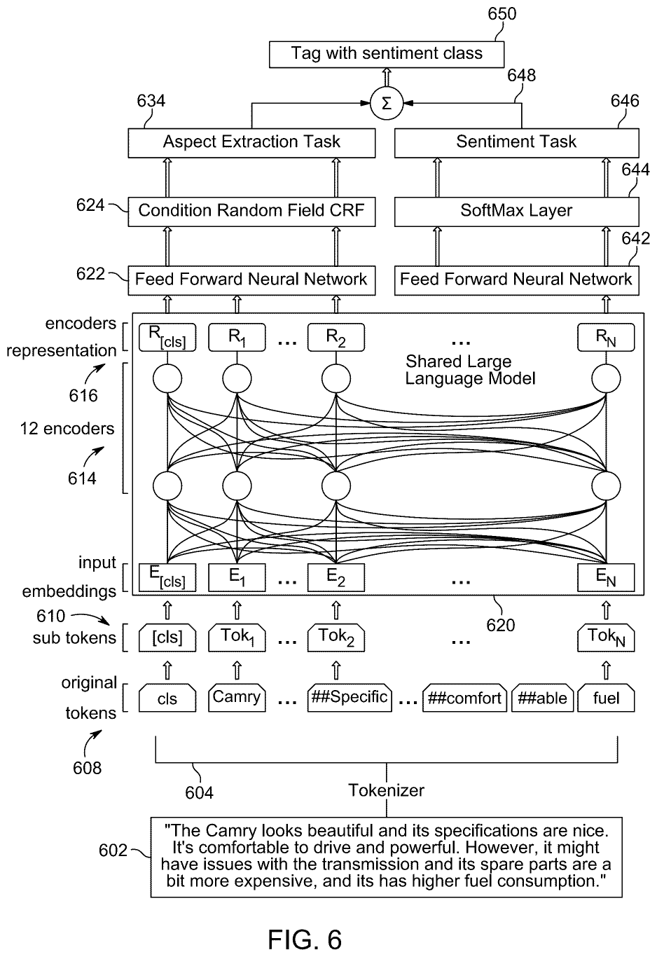

FIG. 5 is an algorithm for building a multi-task model architecture. FIG. 6 is flow diagram for the multi-task model architecture. The single multi-task model architecture consists of a base model (e.g., BERT) and two task-specific heads: one for aspect recognition and another for sentiment classification. This architecture has several components as follows.

The multi-task learning architecture consists of a pre-trained shared language model as the base model, followed by task-specific heads for aspect recognition, including product name recognition and brand name recognition, and sentiment classification.

Shared Language model 620 (SLM): A pre-trained Language model (such as BERT, GPT, DeBERTa, ROBERTa, ELECTRA) is used as the base model, which is responsible for learning contextualized representations of the input text 602. This base model has several layers of transformers 614 and a final output layer 616 that produces hidden states H for each token in the input sequence X. Additionally, it also may include a pooling layer that generates a pooled output, which is typically used for sentence-level tasks.

Aspect recognition head (Aspect Extraction Task 634): A linear layer 622 (feed forward neural network FF) is added on top of the base model's hidden states H to perform token-level classification for aspect recognition. This linear layer 622 takes the hidden states of each token in the input sequence and outputs logits for aspect labels. A conditional random field (CRF) layer 624 is then added on top of the linear layer 622 to model the dependencies between the adjacent aspect labels and capture more complex relationships in the sequence. The CRF models predictions as a graphical model, which represents the presence of dependencies between the predictions. The graphical model may be a linear chain in which each prediction is dependent on its immediate neighbors.

Sentiment classification head (Sentiment Analysis Task) 646: Another linear layer 642 (feed forward neural network FF) is added on top of the base model's pooled output (Pool(H)) for sentiment classification. This linear layer 642 takes the pooled output, which represents the entire input sequence, and outputs logits for sentiment labels (positive, negative, or neutral).

During the forward pass, the model calculates CRF-based losses and predictions for each task if their corresponding label inputs are provided.

The architecture follows a hard parameter sharing approach, where the base model's parameters are shared across all tasks. The task-specific head for aspect recognition 634 is configured to recognize all aspects, including product and brand names, as part of the aspect recognition task. The CRF layer 632 in the aspect recognition head helps capture the dependencies between adjacent labels and model more complex relationships in the sequence. The sentiment classification head 646 is configured to perform sentiment analysis using the shared representations from the base model.

During training, the ground truth aspect label sequence includes the product and brand names as labels, and the model learns to recognize them as aspects. The loss function for the modified model is a weighted sum 648 of the aspect loss and the sentiment loss, with the weights chosen to balance their contributions to the overall loss. The aspect loss is calculated using the modified ground truth aspect label sequence that includes the product and brand names as labels.

In the model architecture, an input sentence 602, represented as X, is tokenized in a tokenizer 604 prior to its integration into the large language model (LLM). During this process, the sentence x is augmented to reach the maximum sequence length by adding padding. The tokenized X 606, along with an accompanying attention mask 608, is then passed through the model, producing contextual embeddings of X 610. The LLM model 620, being a transformer model, utilizes multiple distinct attention mechanisms within each layer, with a total of 12×12 attention heads. This configuration allows each token to connect with 12 distinct features of any other token within the sequence.

The output of the LLM 620 has two key features crucial for accurate classification: prediction scores and hidden states (H). The prediction scores, obtained from the output of the final layer 616 of the model 620, represent the result of all attention heads across all layers and are dependent on parameters such as batch size, hidden state size, and sequence length. Meanwhile, the hidden states (H) are the outputs of the individual layers, with the total number equal to the number of layers+1. The output from one layer serves as the input for the next, further contextualizing its content through its own attention heads. Subsequently, the prediction score can be viewed as a hidden state generated by the final layer 616 of the LLM 620.

The output of the model can be interpreted in multiple ways. While it may be intuitive to assume that the last layer encompasses all information gained through the different stages of learning and therefore, its output should be considered relevant regardless of the transformations made to the input vectors as they pass through the layers, it is possible that some of the vector modifications unintentionally eliminate useful information that could have contributed to a more accurate prediction. To mitigate this, the input vectors can be concatenated partially or completely, or their sum can be utilized. Experiments have shown that this concatenation procedure provides a significant improvement in terms of accuracy, which is why it was employed. The model also includes a linear layer 622 that transforms the output of the LLM 620 into three dimensions (batch size, number of tags, sequence length), which is then passed to a CRF layer 624 responsible for making predictions regarding the probabilities for each of the tags (P_{AE}).

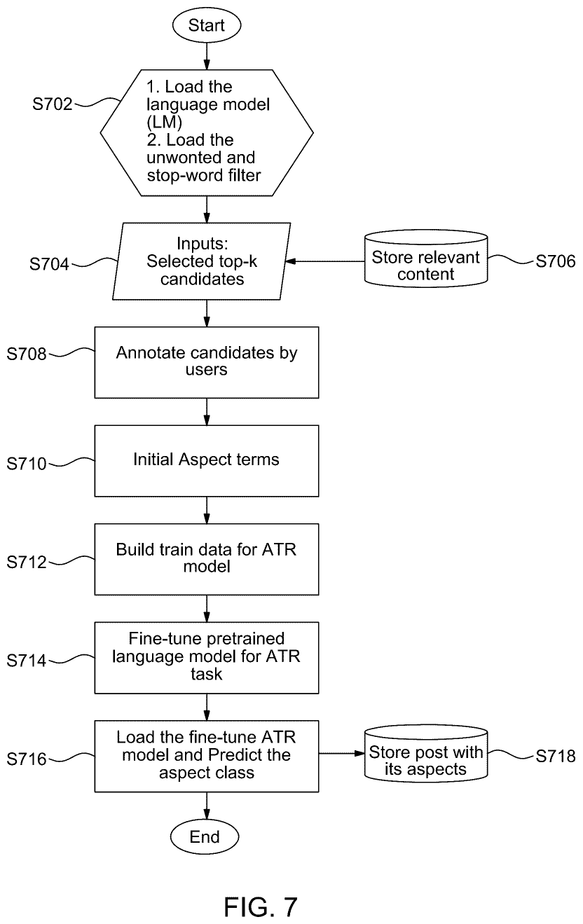

FIG. 7 is a flowchart for modeling and prediction of an aspect class for a product/service. For query terms that are aspects, a machine learning model may be trained to automatically extract aspects for product/service-related content. The modeling process begins with a pretrained large language model and an unwanted and stop-word filter, uploaded in step S702. In step S704, selected top k candidate aspects are input as queries from stored content, S706.

The steps proceed as S708, review textual content and identify relevant aspect candidates; step S710, determine initial aspect terms or phrases that relate to product/service features or characteristics, and determine sentiment expressed towards each identified aspect; step S712, build training data by marking aspect terms and associate them with appropriate sentiment labels; step S714, fine tune a pretrained language model for aspect term recognition; and step S716, load the fine-tuned model and perform a prediction of the aspect class for a product/service. In step S718, the predicted aspect classes are stored with the respective textual content.

### Data Annotation

In the model building process of FIG. 7, novel datasets can be constructed for measuring more than 8 products/services reputation. By annotating a huge number of posts, tweets, and reviews with aspect terms and associated sentiment labels, a unique, specialized dataset is created that is tailored for the specific task of measuring products/service reputation.

This specialized dataset can be used to:
Train a machine learning model, such as an LLM, to automatically recognize aspects and perform sentiment analysis for product/service-related content.
Evaluate the performance of the model on the specific task of several product and service reputation measurement.
Investigate the relationships between various aspects and sentiment labels in various domains, such as car domain, which can provide valuable insights, such as for car manufacturers, marketers, and consumers.
Benchmark the performance of different machine learning models and algorithms on this specialized task, promoting further research and development in the field.

Overall, building a novel dataset for measuring product reputation, such as cars, can help improve the accuracy and effectiveness of the reputation measurement system and contribute to the advancement of NLP and machine learning techniques in the industry.

To annotate the collected data, annotators read through each post, tweet, or review, and identify relevant aspects and sentiment labels. Using cars as an example, this process involves the following sub-steps:
a) Read the content: In S708, annotators carefully read the text to understand the context and identify aspects related to cars and the sentiment expressed towards them.
b) Aspect identification: In S710, annotators recognize specific aspect terms or phrases within the content that relate to different car features or characteristics.
c) Sentiment labeling: Annotators determine the sentiment (positive, negative, or neutral) expressed towards each identified aspect based on the context and tone of the content.
d) Annotation: In S712, annotators use a selected annotation tool to mark the aspect terms and associate them with the appropriate sentiment label.

During the annotation, annotators mark the aspect terms in the text and assign sentiment labels accordingly. The resulting annotated data provides valuable information for training the LLM to perform aspect recognition and sentiment analysis in the product/service reputation measurement system 100.

### Training Multi-Task Model

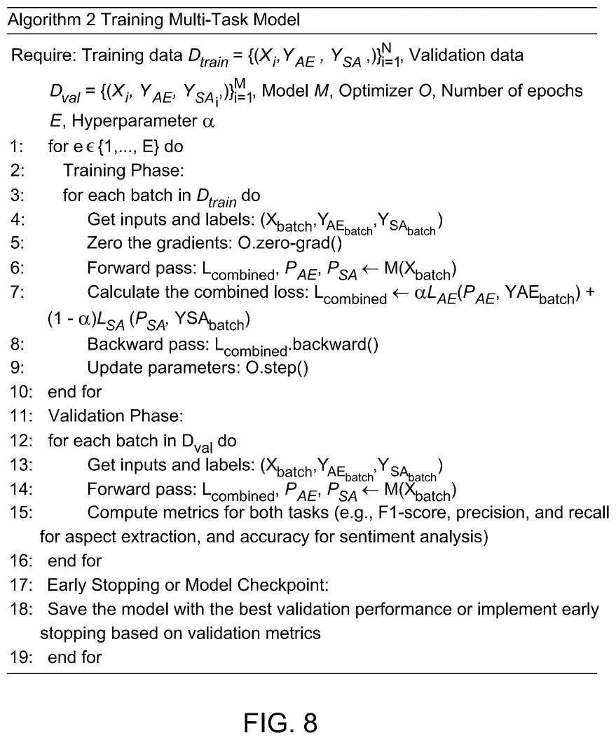

In this section, the training and evaluation process is described for the multi-task model, which simultaneously learns aspect extraction and sentiment analysis from an example dataset of more than 400K labeled and preprocessed social media posts and reviews on cars. The model utilizes a shared LLM backbone 620 (which can be BERT, GPT, ELECTRA, DEBERTA, ROBERTA etc.) with task-specific layers to learn and generalize from this large dataset effectively. Algorithm 2 (shown in FIG. 8) explains the complete training process of the model.

### Data Preparation

An exemplary non-limiting dataset may include 400,000 social media posts and reviews related to cars. Each instance in the dataset is a preprocessed text sequence (e.g., including removal of unwanted and stop-words), along with aspect term labels and sentiment analysis labels. The dataset is divided into three parts: 80% for training, 10% for validation, and 10% for testing. The validation set is used for hyperparameter tuning and early stopping, while the test set is reserved for the final evaluation of the model.

### Model Configuration and Hyperparameter Tuning

The multi-task model and other components of the system 100 are implemented as code on a computer system. As such, variables in the code are expressed using a $ sign throughout this disclosure.

The multi-task model uses the LLM backbone 620, which serves as a shared feature extractor for two tasks. Task-specific layers are added for aspect extraction 634 and sentiment analysis 646 on top of the LLM backbone 620. The aspect extraction task 634 uses a feedforward layer 622 followed by a CRF layer 624, while the sentiment analysis task 646 employs a pooling operation, a feedforward layer 642, and a softmax layer 644.

To find the optimal hyperparameters for the model, a comprehensive search is performed using techniques such as grid search or Bayesian optimization. Various hyperparameters are considered, including learning rate, batch size, number of epochs, $\alpha$ (the trade-off between the two tasks in the combined loss function), LLM backbone variant, dropout rate, weight initialization, and optimizer.

A validation set is used to evaluate the model during the hyperparameter search process. The best combination of hyperparameters is selected based on the validation performance, measured by metrics such as F1 score for aspect extraction and accuracy for sentiment analysis.

### Training Process

With the optimal hyperparameters identified, in step S714, the multi-task model is trained on the training dataset. During each epoch, the data is processed in mini-batches, updating the model parameters using a batched gradient descent algorithm such as Adam or RMSprop.

The combined loss function for aspect extraction and sentiment analysis is used to optimize the model parameters. The combined loss is a linear combination 648 of the aspect extraction loss (negative log-likelihood NLL) and sentiment analysis loss (cross-entropy), controlled by the hyperparameter $\alpha$. The model is trained to minimize the combined loss to improve its performance on both tasks.

An early stopping is employed based on the validation performance to prevent overfitting and reduce training time. The model training is stopped when the validation performance does not improve for a predefined number of consecutive epochs.

### Evaluation Metrics

To evaluate the performance of the model, several evaluation metrics are considered for both aspect extraction and sentiment analysis tasks. For aspect extraction, precision, recall, and F1 score, are used which provide a comprehensive assessment of the model's ability to identify aspects accurately. For sentiment analysis, accuracy, precision, recall, and F1 score per sentiment class, as well as macro-averaged F1 score are used to evaluate the overall performance of the model.

### Model Evaluation

After training, in S716, the multi-task model is evaluated on the test dataset, which has not been used during training or hyperparameter tuning. This evaluation allows the model's generalization performance to be assessed on unseen data. The evaluation metrics are computed for both aspect extraction and sentiment analysis tasks and to compare the model's performance against baseline methods and state-of-the-art models in the literature.

The notations used in the training process are summarized in the following table.

TABLE 1
Notations and Descriptions

| Notation | Description |
|---|---|
| X | Sequence of tokens in the input data |
| Y_{AE} | True labels for aspect extraction |
| Y_{SA} | True labels for sentiment analysis |
| H | Hidden states generated by the shared |
| | BERT backbone |
| H_{AE} | Hidden states for the aspect extraction task |
| H_{SA} | Hidden states for the sentiment analysis task |
| P_{AE} | Predicted probabilities for aspect extraction |
| P_{SA} | Predicted probabilities for sentiment analysis |
| L_{AE} | Loss for aspect extraction |
| L_{SA} | Loss for sentiment analysis |
| L_{combined} | Combined loss for aspect extraction and |
| | sentiment analysis |
| α | Hyperparameter controlling the trade-off |
| | between the two tasks |
| T | Number of tokens in the input sequence |
| C | Set of possible sentiment classes |

### Loss Function

Given the two tasks, aspect extraction and sentiment analysis, the combined loss function is defined as follows:

Let L_{AE} be the negative log-likelihood (NLL) loss for aspect extraction, and let L_{SA} be the cross-entropy loss for sentiment analysis. These two losses can be combined using a weighted sum, where a is a hyperparameter in the range of 0 to 1 that determines the balance between the two tasks.

The combined loss function L_{combined} can be defined as:

$${L}_{combined} = α {L}_{AE} + ( 1 - α ) {L}_{SA} \qquad ( 1 )$$

### Negative Log-Likelihood (NLL) Loss for Aspect Extraction

Given N training examples, each consisting of a sequence of Tᵢ tokens, and K aspect categories (including a non-aspect label), let pᵢⱼ(k) be the predicted probability of the j-th token in the i-th sequence belonging to the aspect category k, and let yᵢⱼ(k) be the true label, which is 1 if the token belongs to category k and 0 otherwise. The NLL loss for aspect extraction can be defined as:

$${L}_{AE} = - \frac{1}{N} {\sum }_{i = 1}^{N} {\sum }_{j = 1}^{{T}_{i}} {\sum }_{k = 1}^{K} {y}_{ij} ( k ) log {p}_{ij} ( k ) \qquad ( 2 )$$

### Cross-Entropy Loss for Sentiment Analysis

Cross-Entropy Loss for Sentiment Analysis Given N training examples and M sentiment categories (e.g., positive, negative, and neutral), let qᵢ(m) be the predicted probability of the i-th sequence having sentiment m, and let zᵢ(m) be the true label, which is/if the sequence has sentiment m and 0 otherwise. The cross-entropy loss for sentiment analysis can be defined as:

$${L}_{SA} = - \frac{1}{N} {\sum }_{i = 1}^{N} {\sum }_{m = 1}^{M} {z}_{i} ( m ) log {q}_{i} ( m ) \qquad ( 3 )$$

By combining these two loss functions using the weighted sum 648 defined earlier, a multi-task model can be trained for both aspect extraction and sentiment analysis simultaneously.

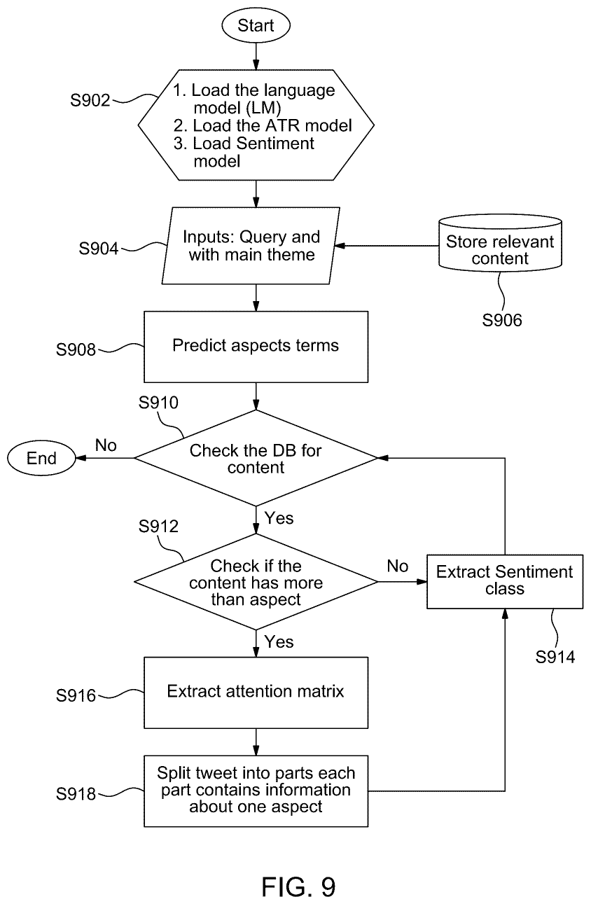

FIG. 9 is a flowchart of aspect sentiment inference. Once the multi-task model has been evaluated, the trained model may be used for inference to determine sentiment class for a product/service query.

In order to perform an inference on a machine, in step S902, a large language model, an aspect task recognition model and a sentiment model are loaded and installed. Once installed, in step S904, a query may be input based on relevant content, retrieved in step S906.

In step S908, the inference may be performed to predict aspect terms using the aspect term recognition model.

In a decision step S910, a database may be checked to determine if it contains textual content for sentiment analysis.

In decision step S912, provided retrieved content, the content is checked to determine if there is more than one aspect. When there is a single aspect, in S914, the system determines a sentiment class for the aspect, and returns to S910 to check for more content.

When there are multiple aspect terms, in S916, an attention matrix is extracted. In S918, the content is split into parts, where each part contains information about one product/service aspect. In S914, a sentiment class is determined for each part and aspect.

The sentiment class extraction step S914 is repeated until there is not more content (NO in S910) for sentiment analysis.

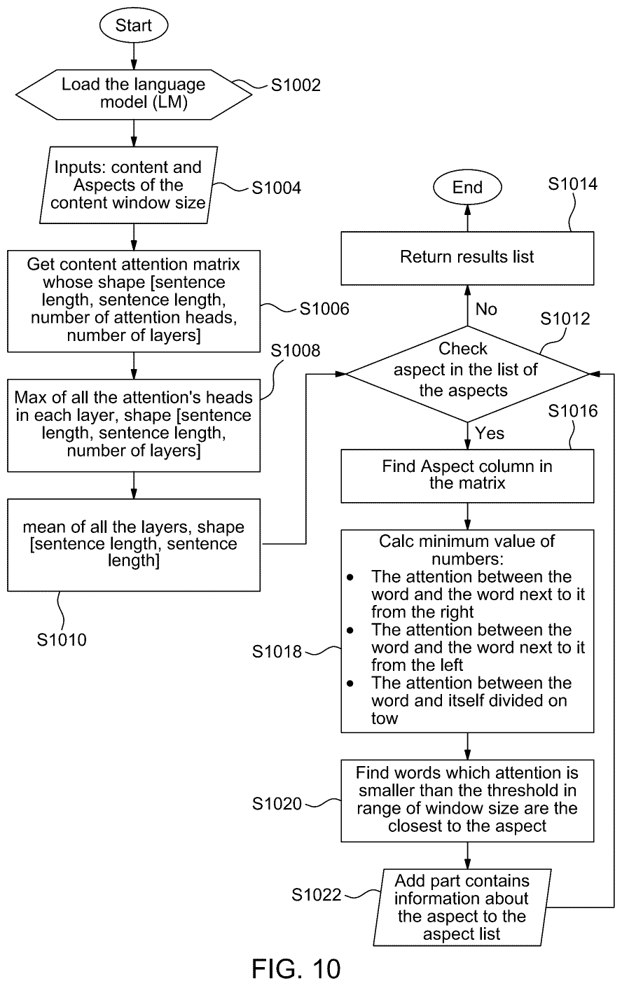

FIG. 10 is a flowchart for a process of building the attention matrix to extract similar aspects. Step S916 is performed in the case that the content has more than one aspect (YES in S912). FIG. 10 is a flowchart for detailed steps for building the attention matrix.

In order to build an attention matrix, in step S1002, a language module must be loaded and installed. Once installed, in step S1004, a content and aspects of the content can be input.

In step S1006, the system forms a content attention matrix whose shape is [sentence length, sentence length, number of attention heads, number of layers].

In step S1008, the system determines the maximum of all attention heads in each layer and forms a matrix having shape [sentence length, sentence length, number of layers].

In step S1010, the system determines a mean of all the layers and forms a matrix having shape [sentence length, sentence length].

In step S1012, aspects in the list of aspects are checked.

Provided an aspect (YES in S1012), in step S1016, find the abstract in the attention matrix.

In step S1018, calculate a maximum value for:
The attention between the word and the word next to it from the right;
The attention between the word and the word next to it from the left; and
The attention between the word and itself divided by two.

In step S1020, find words which have attention smaller than the threshold in a range of window size that are the closest to the aspect list.

In step S1022, add a part that contains information about the aspect to the aspect list. Steps for forming the attention matrix are repeated until all aspects have been checked (NO in S1012), where in step S1014, the resulting aspect matrix is returned.

### Calculating the Reputation Score (156):

The reputation of a product can be assessed based on several factors, including sentiment analysis, frequency analysis, brand mentions, and review score. The initial reputation score can be determined using a reputation score function 156 as follows

$$Reputation Score = {w}_{s} \times Sentiment Score + {w}_{f} \times Frequency Score + {w}_{b} \times Brand Mentions Score + {w}_{r} \times Review Score \qquad ( 4 )$$

In this formula, the Reputation Score is calculated as a weighted sum of four factors: Sentiment Score, Frequency Score, Brand Mentions Score, and Review Score. The weights $w_s$, $w_f$, $w_b$, and $w_r$ reflect the relative importance of each factor in the calculation of the Reputation Score. However, the weights must satisfy the constraint that their sum is equal to 1:

$${w}_{s} + {w}_{f} + {w}_{b} + {w}_{r} = 1 \qquad ( 5 )$$

This constraint ensures that the sum of the weights equals 1, maintaining the balance and proportionality of the components in the Reputation Score. The choice of weights can be adapted to different domains, products, or brands, reflecting the varying importance of each factor in different contexts. To optimize the weights, one can rely on expert opinions, domain knowledge, or empirical analysis of the available data.

The factors are as follows:

Sentiment Score: The sentiment score is calculated using the multi-task model with respect to the aspects.

Frequency Score: The Frequency Score represents the number of times a product is mentioned online and serves as an essential component in assessing this product's reputation. In the multitask model and under the aspect extraction, the model can recognize the product names, models, and brands in the text. Once the product mentions are identified, the Frequency Score can be calculated by counting the total number of mentions across all sources:

$$F = {\sum }_{i = 1}^{n} {m}_{i} \qquad ( 6 )$$

Where $F$ is the Frequency Score, $n$ is the total number of sources, and $m; $ is the number of mentions in source $i$.

Brand Mentions Score: The brand mentions score is calculated by measuring the number of times the brand name is mentioned online. Once the brand mentions are identified, the Brand Score can be calculated by counting the total number of mentions across all sources:

$$B = {\sum }_{i = 1}^{n} {b}_{i} \qquad ( 7 )$$

Where $B$ is the Brand Score, $n$ is the total number of sources, and $b_i$ is the number of brand mentions in source $i$.

Review Score: The review score, which is based on the analysis of customer reviews and ratings, takes into account the average rating of the product, the number of reviews, and the distribution of ratings. The review score, based on the analysis of customer reviews and ratings, takes into account the average rating of the product, the number of reviews, and the distribution of ratings. The Review Score can be calculated using the following components:
Review Count: Count of the total number of reviews for the product.
Rating Distribution: Analysis of the distribution of ratings (e.g., the percentage of 1-star, 2-star, 3-star, 4-star, and 5-star ratings).

In order to ensure that the Review Count contributes meaningfully to the Review Score calculation, the review score can be normalized using the min-max normalization method. Here's how the normalized Review Count can be calculated:

Let $C$ be the raw Review Count for a specific car product. Let $C_{min} $ and $C_{max} $ be the minimum and maximum Review Counts observed in the dataset, respectively. The normalized Review Count can then be calculated as:

$${C}_{normalized} = \frac{C - {C}_{min}}{{C}_{max} - {C}_{min}} \qquad ( 8 )$$

Where:
$C_{normalized} $ is the normalized Review Count
$C$ is the raw Review Count for a specific car product
$C_{min} $ and $C_{max} $ are the minimum and maximum Review Counts observed in the dataset, respectively.

By normalizing the Review Count, a more balanced representation of a product's reputation can be ensured when combined with other factors, such as the Average Rating or Rating Distribution. This makes the final Review Score calculation more robust and less sensitive to extreme values in the dataset.

The accuracy of the Review Score can be improved by using the Rating Distribution as the weights assigned to each component in the Review equation. Define the Rating Distribution metric as a vector containing the percentage of ratings in each category:

$$D = [ {d}_{1} , {d}_{2} , {d}_{3} , {d}_{4} , {d}_{5} ] \qquad ( 9 )$$

Where $d_i$ is the percentage of ratings in the $i$-th category. In considering both the Rating Distribution and the normalized Review Count in the equation, a weighted sum of the Rating Distribution and normalized Review Count can be calculated. Here is one example formula:

$$R = {\sum }_{i = 1}^{k} {d}_{i} \cdot {r}_{i} + {w}_{c} \cdot {C}_{normalized} \qquad ( 10 )$$

In this formula, $R$ represents the Review Score. The summation over $i$ represents the weighted sum of ratings using the Rating Distribution as weights. $d_i$ represents the percentage of ratings in the $i$-th category from the Rating Distribution vector $D$, and $r_i$ represents the rating value corresponding to the $i$-th category.

The second term in the formula represents the weighted normalized Review Count, where $w_c$ is the weight assigned to this component, and $C_{normalized}$ is the normalized Review Count calculated using the min-max normalization method.

By combining these factors with their respective weights, a composite Reputation Score provides a comprehensive measure of a product's reputation. This composite score takes into account various aspects of product perception, offering a holistic assessment of its reputation in the open web.

It is important to note that the choice of weights in the formula may vary depending on the specific domain, product, or brand under consideration. For example, certain industries may prioritize sentiment analysis more than others, leading to a higher weight for the Sentiment Score. In such cases, it is crucial to carefully choose the weights to accurately reflect the importance of each factor for the target product or brand. Additionally, the weights can be fine-tuned based on expert opinions, domain knowledge, or empirical analysis of the available data. To determine the importance of the weights for the reputation score two alternative approaches are:

Domain Expertise: Consulting with domain experts who have a deep understanding of the industry or market can provide valuable insights into the relative importance of the different factors contributing to the reputation score. Domain experts can help assign appropriate weights based on their knowledge and experience. This approach relies on human judgment and qualitative analysis, but it can be beneficial in situations where data is scarce or difficult to obtain

Feature Importance Techniques: Using feature importance techniques from machine learning can help estimate the importance of each component in the reputation score. One can train a model, such as a decision tree, random forest, or gradient boosting machine, on a dataset with ground truth reputation scores and their corresponding Sentiment Scores ($S$), Frequency Scores ($F$), Brand Mentions Scores ($B$), and Review Scores ($R$). After training the model, the feature importance provided by the model is analyzed to understand the relative importance of each component in predicting the reputation score.

Finally, considering the product/service aspects in the Reputation formula, one can modify it to include the sentiment and relevance of each aspect to the product. The modified Reputation equation:

[symbol]

In this formula, the Reputation score for the product/service is calculated as a weighted sum of several components. The weights $w_s$, $w_f$, $w_b$, $w_r$, and $w_{a_j}$ are assigned to each component in the formula (i.e., sentiment, frequency, brand mentions, review score, and aspect sentiment, respectively). The sentiment score $\text{Senti}_i$ is the sentiment score for the $i$-th source (calculated using sentiment analysis techniques). The frequency score $\text{Freq}_i$ is the frequency score for the $i$-th source (calculated using frequency analysis techniques). The brand mentions score $\text{Brand}_i$ is the brand mentions score for the $i$-th source (calculated using brand mention analysis techniques). The review score $\text{Review}_i$ is the review score for the $i$-th source (calculated using the formula described in the previous section).

The term $\sum_{j=1}\hat{ }{m_i} w_{a_j} \times \text {Asp} {i,j} \times Big (w_{s_j} \times \text {Senti}_{i,j}+w_{f_j} \times \text {Freq}_{i,j}\Big)$ calculates the sentiment and frequency of each relevant aspect extracted from the $i$-th source, where $m_i$ is the number of aspects extracted from the $i$-th source, $\text {Asp}_{i,j}$ is the relevance score of the $j$-th aspect to the car product for the $i$-th source, $\text {Senti}_{i,j}$ is the sentiment score of the $j$-th aspect for the $i$-th source, and $\text{Freq}_{i,j}$ is the frequency score of the $j$-th aspect for the $i$-th source.

The weights for each component, as well as the aspect-specific weights, can be adjusted based on domain expertise and data analysis. By considering the aspects in the Reputation formula, a more fine-grained evaluation of a product's/service's reputation, can be provided taking into account the sentiment and frequency of different aspects relevant to the product/service.

### Data-to-Knowledge (152)

The main role of the Data-to-Knowledge function 152 is to establish the links between data storage and active elements of the solution by using a number of object libraries. The function can draft a blueprint for data storage when a new request is sent, allowing the solution to save a broad range of heterogeneous data related to the processed opinions. This trove of data and the corresponding characteristics can later be used to perform complex operations and fulfill the primary intention of the solution, performed using the Data-to-Knowledge function 152.

This function is closely coordinated with the previous one, teaming up to ensure that information originally collected from the open-web and stored in an SQL database can be properly utilized. In this function, well-defined data that have informational value can be fed into the visual representation module 140. The visualization representation module 140 can display results of analyses including:
1. Product performance: The system tracks the performance of products over time and identifies trends or patterns that may be affecting their reputation. The system can display a comparison a Reputation score of a product to their competitors' scores to identify areas where they may be falling behind or excelling.
2. Aspect analysis: The system can store the aspect sentiment scores and display aspects of products that are generating the most positive or negative sentiment among customers. This can help identify areas for improvement and focus efforts on addressing the most critical issues.
3. Brand image: The system can store the brand mention scores to monitor brand image and can identify and display any negative or positive mentions online. This can help to identify any potential issues that need to be addressed and track the effectiveness of their brand management efforts.
4. Review analysis: The system can store the review scores and review count to monitor customer feedback and identify and display any common themes or issues that are frequently mentioned in customer reviews. This can help to identify areas for improvement and make data-driven decisions about product development and marketing strategies.
5. Sentiment analysis: The system can store the sentiment scores over time in order to monitor the overall sentiment of customer feedback and identify and display changes over time. This can help to identify emerging issues or trends so that proactive changes can be addressed.
6. Pricing analysis: The system can store the Reputation score to understand how pricing may be affecting a product's reputation. The system can display a comparison of a Reputation score for a product to competitors' scores to understand how their pricing strategy may be affecting their competitiveness in the market.
7. Customer segmentation: The system can store the Reputation score and use it to segment customers based on their sentiment towards the product. The segments of customers and reputation scores can be displayed to help in understanding the needs and preferences of different customer segments and tailor a product and marketing strategies accordingly.

These analyses can provide companies with valuable insights into their product's reputation and customer feedback, helping them make data-driven decisions about product development, marketing, and brand management strategies.

### Solution Deployment

The present disclosure relates to a system having an interactive interface and dashboard that helps a user decide on acquiring a particular product/service based on the ratings and comments collected and analyzed from the open web. A data acquisition layer performs data collection from multiple sources to gather the most significant possible number of product reviews. A user can benefit from the rating collected from all other stores by searching only one system. In addition, the system can compare any product to any competitor's product. By inputting the product or brand name and selecting the data source, for example, tweets, the system will display the result as a list of all the tweets related to the entered name of the product or brand. A chart can be displayed that illustrates that sentiment analysis by classifying the tweets into positive, negative, and neutral based on each product's/service's aspects.

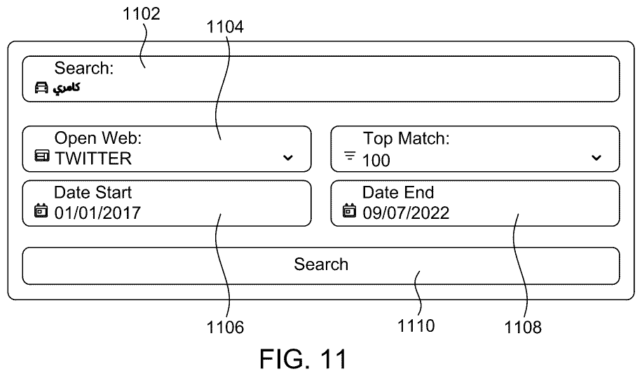

The system helps the user to decide to buy a particular product and compare it with its peers in the market based on multiple factors so that his decision is covered in all aspects, more comprehensive and precise. Then, the system searches for the product based on a user-entered name 1102 and a specified source of the data 1104, for example, searching for a Camry car in Twitter data and the period from 2017 to 2022 (1104, 1106), as shown in FIG. 11.

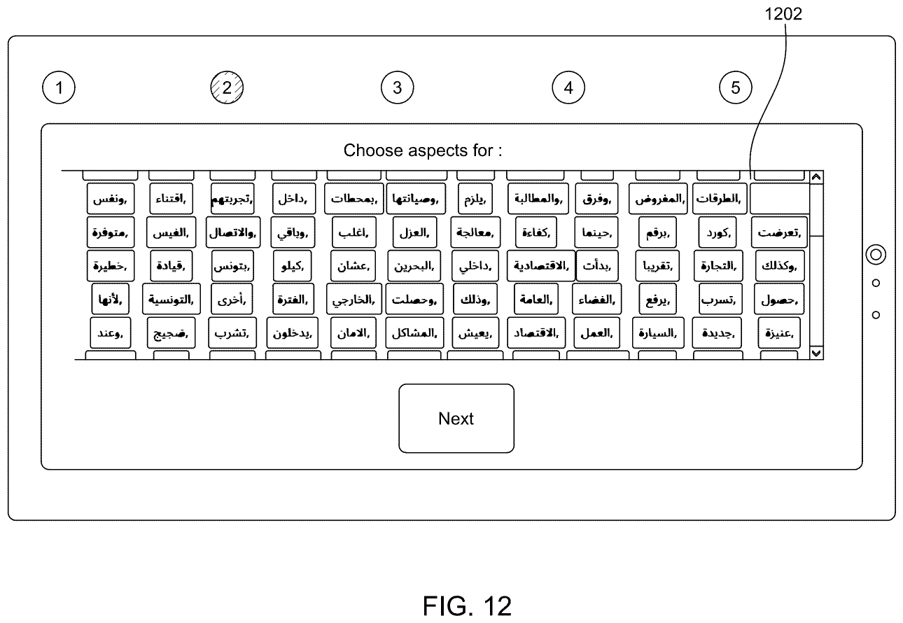

When the user clicks on the “Search” button 1110, the system displays, as shown in FIG. 12, the results as a list of all tweets related to the search entries, as the system fetches data from the open web in real time.

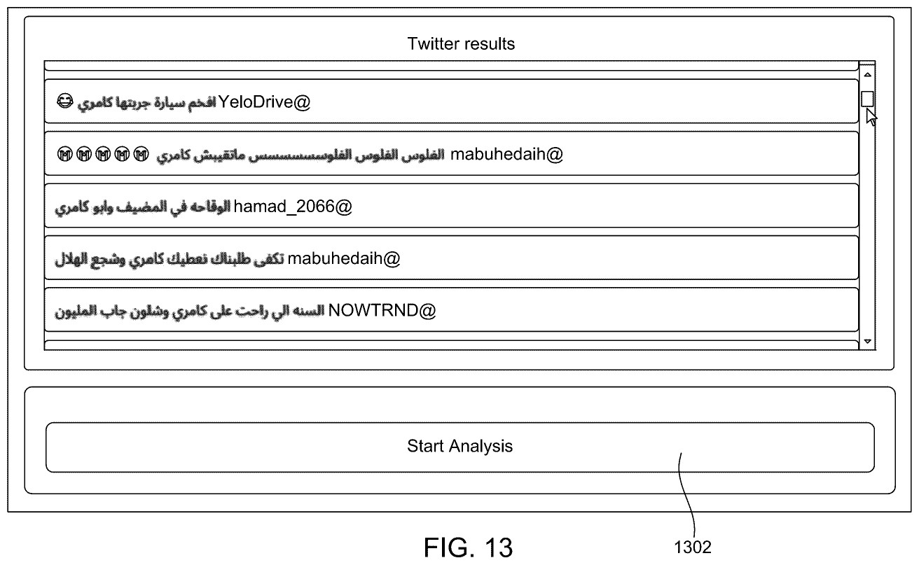

After clicking “Start Analysis” 1302 in FIG. 13, the system will analyze the results and display them on three pages; a user can jump into any of the pages by scrolling the bar.

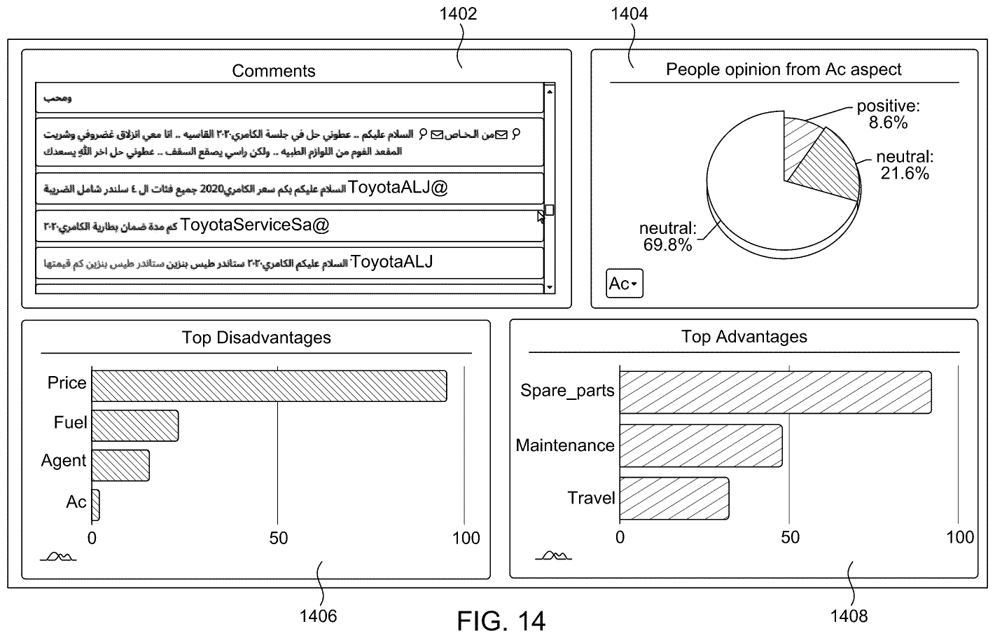

As illustrated in FIG. 14, the first page is displayed separated into four parts: Comments 1402, a pie chart of People's Opinions 1404, a Bar-chart of Top Disadvantages 1406, and a Bar-chart of Top Advantages 1408.

Comments 1402: contains a list of the tweets

Pie chart of People's Opinions 1404: displays the positive, negative, and neutral people's opinions based on aspects selected from a dropdown list. In the example, the selected product aspects of a car as a product are AC, Agent, Fuel, Made_in, Maintenance, Model, Price, Spare parts, and Travel. The system analyzes people's opinions based on the selected product aspects. FIG. 14 shows people opinion from the AC aspect.

Bar chart of Top Disadvantages 1406: is displayed to illustrate the top aspects that have negative analysis.

Bar-chart of Top Advantages 1408: is displayed to illustrate the top product aspects that have positive analysis.

For example, as illustrated in FIG. 14, the top advantages of Camry are spare parts, maintenance, and travel. On the other hand, the top disadvantages are price, fuel, agent, and ac. So, a user can conclude that if one is concerned about owning the car, the availability of spare parts, and the possibility of repairing them after purchase while maintaining its quality (Maintenance), in addition to comfort and stability during travel, then the choice of Camry is correct. However, on the other hand, it is considered an expensive car and uneconomical in consuming gasoline. In addition, its agent is not good, and the air ac is not considered very good, but it is not considered very bad because it is at the bottom of the list of disadvantages and in a percentage that is not more than 5%.

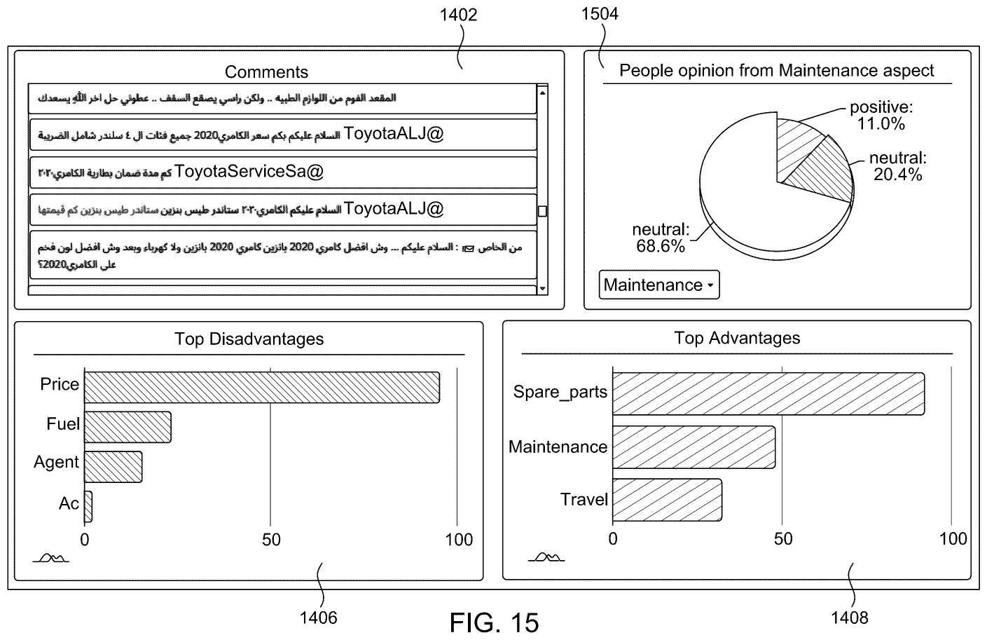

As illustrated in FIG. 15, the pie chart 1502 is produced from the perspective of the maintenance aspect.

The second page can display the sentiment analysis of tweets per year based on the selected aspect, the most frequent words, and the sentiment timeline (per month of the year chosen). In the example, Camry was better in 2017 and worse in 2022.

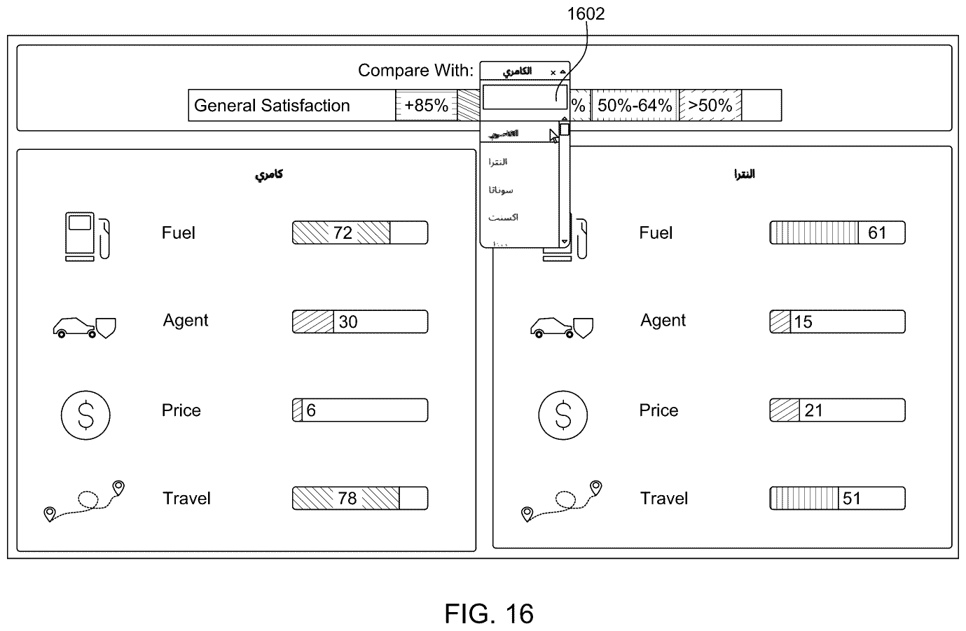

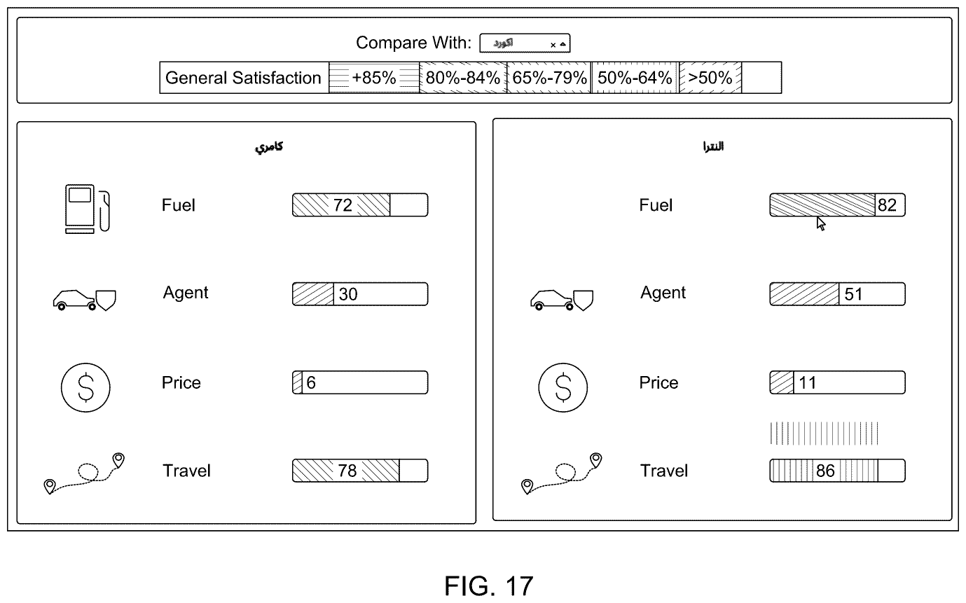

To make a clear decision about a specific product and make sure it's the most suitable choice, one may compare it with other products. In the example, Camry can be compared with other cars based on the general statistics of each aspect. For example, FIG. 16 or FIG. 17 are example displays of product comparisons. A specific product can be compared with another product, chosen from a drop-down menu 1602. In a further display, a first competitor of Camry is Elantra, and other competitors are ranked based on the sentiment analysis of the top advantages.

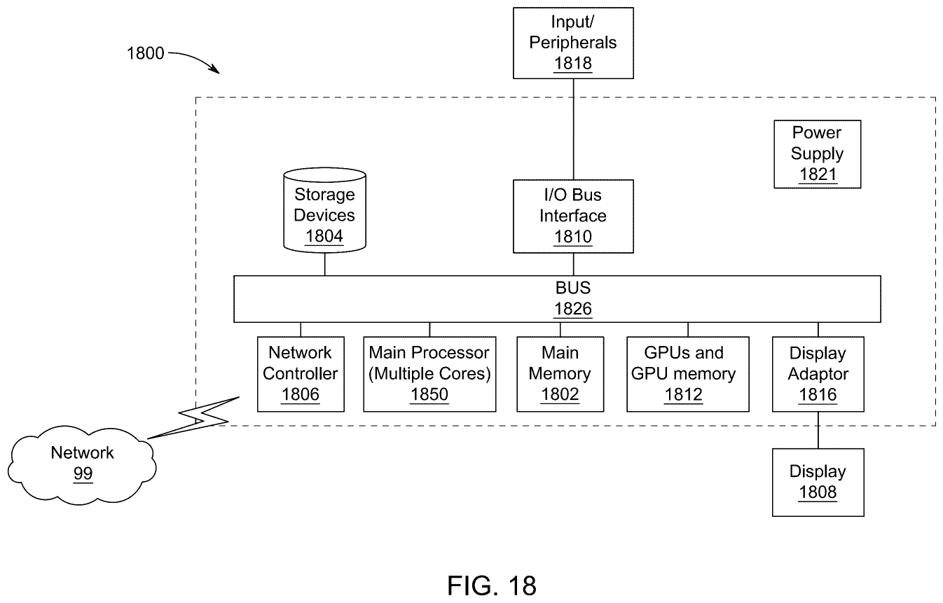

Next, further details of the hardware description of an exemplary computing environment for performing the program instructions according to embodiments is described with reference to FIG. 18.

FIG. 18 is a block diagram illustrating an example computer system for implementing the machine learning training and inference methods according to an exemplary aspect of the disclosure. The computer system may be an AI workstation running an operating system, for example Ubuntu Linux OS, Windows, a version of Unix OS, or Mac OS. The computer system 1800 may include one or more central processing units (CPU) 1850 having multiple cores. The computer system 1800 may include a graphics board 1812 having multiple GPUs, each GPU having GPU memory. The graphics board 1812 may perform many of the mathematical operations of the disclosed machine learning methods. The computer system 1800 includes main memory 1802, typically random access memory RAM, which contains the software being executed by the processing cores 1850 and GPUs 1812, as well as a non-volatile storage device 1804 for storing data and the software programs. Several interfaces for interacting with the computer system 1800 may be provided, including an I/O Bus Interface 1810, Input/Peripherals 1818 such as a keyboard, touch pad, mouse, Display Adapter 1816 and one or more Displays 1808, and a Network Controller 1806 to enable wired or wireless communication through a network 99. The interfaces, memory and processors may communicate over the system bus 1826. The computer system 1800 includes a power supply 1821, which may be a redundant power supply.

In some embodiments, the computer system 1800 may include a server CPU and a graphics card by NVIDIA, in which the GPUs have multiple CUDA cores. In some embodiments, the computer system 1800 may include a machine learning engine 1812.

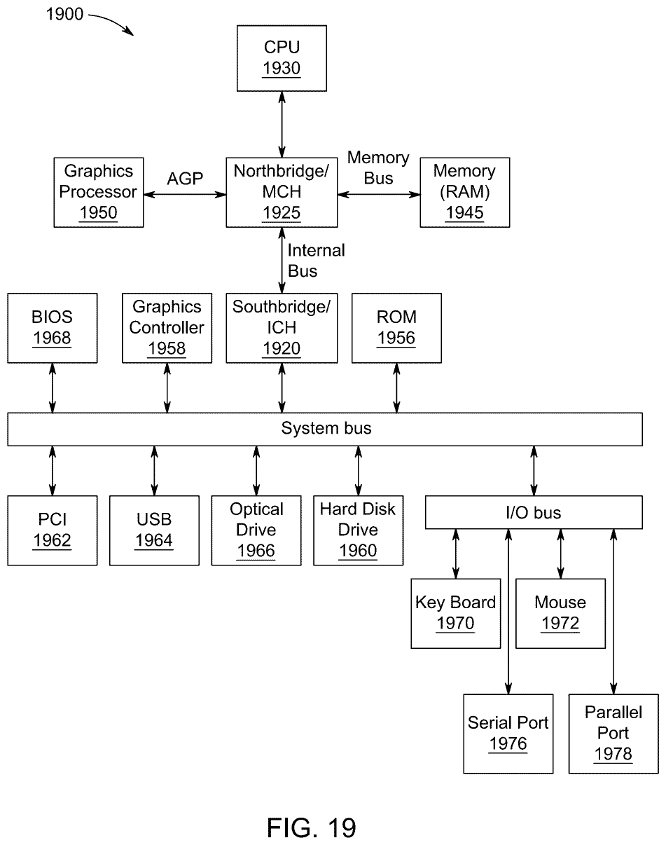

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 19.

FIG. 19 shows a schematic diagram of a data processing system 1900 used within the computing system, according to exemplary aspects of the present disclosure. The data processing system 1900 is an example of a computer in which code or instructions implementing the processes of the illustrative aspects of the present disclosure may be located.

In FIG. 19, data processing system 1980 employs a hub architecture including a north bridge and memory controller hub (NB/MCH) 1925 and a south bridge and input/output (I/O) controller hub (SB/ICH) 1920. The central processing unit (CPU) 1930 is connected to NB/MCH 1925. The NB/MCH 1925 also connects to the memory 1945 via a memory bus, and connects to the graphics processor 1950 via an accelerated graphics port (AGP). The NB/MCH 1925 also connects to the SB/ICH 1920 via an internal bus (e.g., a unified media interface or a direct media interface). The CPU Processing unit 1930 may contain one or more processors and even may be implemented using one or more heterogeneous processor systems.

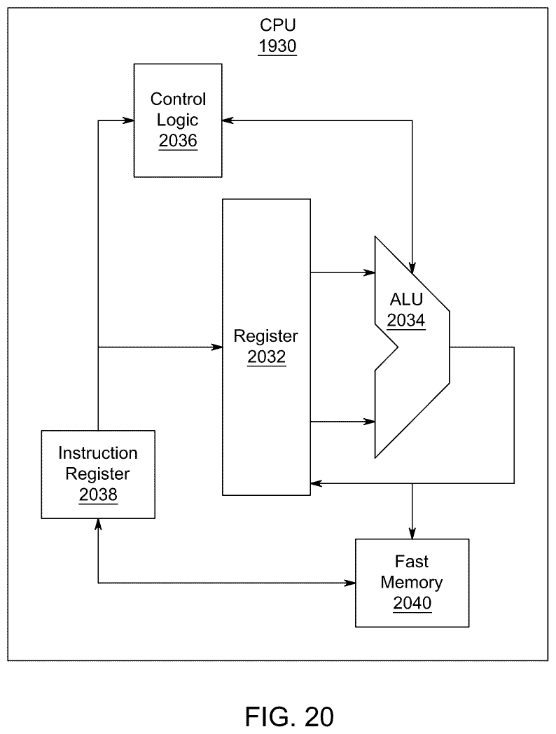

For example, FIG. 20 shows one aspects of the present disclosure of CPU 1930. In one aspects of the present disclosure, the instruction register 2038 retrieves instructions from the fast memory 2040. At least part of these instructions is fetched from the instruction register 2038 by the control logic 2036 and interpreted according to the instruction set architecture of the CPU 1930. Part of the instructions can also be directed to the register 2032. In one aspects of the present disclosure the instructions are decoded according to a hardwired method, and in another aspect of the present disclosure the instructions are decoded according to a microprogram that translates instructions into sets of CPU configuration signals that are applied sequentially over multiple clock pulses. After fetching and decoding the instructions, the instructions are executed using the arithmetic logic unit (ALU) 2034 that loads values from the register 2032 and performs logical and mathematical operations on the loaded values according to the instructions. The results from these operations can be feedback into the register and/or stored in the fast memory 2040. According to certain aspects of the present disclosures, the instruction set architecture of the CPU 1930 can use a reduced instruction set architecture, a complex instruction set architecture, a vector processor architecture, a very large instruction word architecture. Furthermore, the CPU 1930 can be based on the Von Neuman model or the Harvard model. The CPU 1930 can be a digital signal processor, an FPGA, an ASIC, a PLA, a PLD, or a CPLD. Further, the CPU 1930 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 19, the data processing system 1980 can include that the SB/ICH 1920 is coupled through a system bus to an I/O Bus, a read only memory (ROM) 1956, universal serial bus (USB) port 1964, a flash binary input/output system (BIOS) 1968, and a graphics controller 1958. PCI/PCIe devices can also be coupled to SB/ICH 1920 through a PCI bus 1962.

The PCI devices may include, for example, Ethernet adapters, add-in cards, and PC cards for notebook computers. The Hard disk drive 1960 and CD-ROM 1956 can use, for example, an integrated drive electronics (IDE) or serial advanced technology attachment (SATA) interface. In one aspects of the present disclosure the I/O bus can include a super I/O (SIO) device.

Further, the hard disk drive (HDD) 1960 and optical drive 1966 can also be coupled to the SB/ICH 1920 through a system bus. In one aspects of the present disclosure, a keyboard 1970, a mouse 1972, a parallel port 1978, and a serial port 1976 can be connected to the system bus through the I/O bus. Other peripherals and devices that can be connected to the SB/ICH 1920 using a mass storage controller such as SATA or PATA, an Ethernet port, an ISA bus, an LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

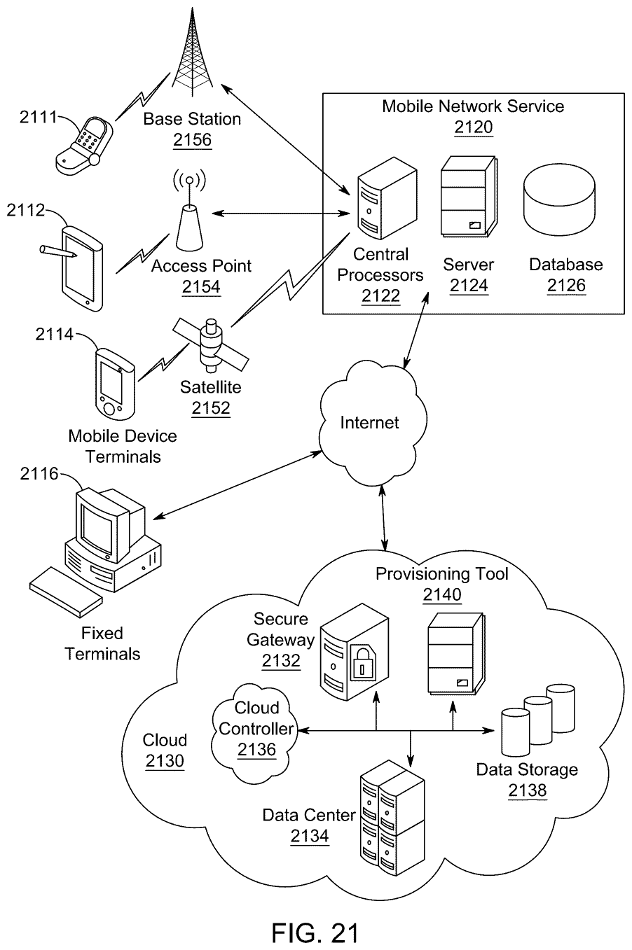

The functions and features described herein may also be executed by various distributed components of a system. For example, one or more processors may execute these system functions, wherein the processors are distributed across multiple components communicating in a network. The distributed components may include one or more client and server machines, which may share processing, as shown by FIG. 21, in addition to various human interface and communication devices (e.g., display monitors, smart phones, tablets, personal digital assistants (PDAs)). More specifically, FIG. 21 illustrates client devices including smart phone 2111, tablet 2112, mobile device terminal 2114 and fixed terminals 2116. These client devices may be commutatively coupled with a mobile network service 2120 via base station 2156, access point 2154, satellite 2152 or via an internet connection. Mobile network service 2120 may comprise central processors 2122, server 2124 and database 2126. Fixed terminals 2116 and mobile network service 2120 may be commutatively coupled via an internet connection to functions in cloud 2130 that may comprise security gateway 2132, data center 2134, cloud controller 2136, data storage 2138 and provisioning tool 2140. The network may be a private network, such as a LAN or WAN, or may be a public network, such as the Internet. Input to the system may be received via direct user input and received remotely either in real-time or as a batch process. Additionally, some aspects of the present disclosure may be performed on modules or hardware not identical to those described.

Numerous modifications and variations of the present invention are possible in light of the above teachings. It is therefore to be understood that within the scope of the appended claims, the invention may be practiced otherwise than as specifically described herein.

1. A method for measuring reputation of a product or service based on customer reviews and social media mentions, comprising:
cyclically refining a search to collect, using a natural language processing (NLP) model via processing circuitry, data relating to the product or service; and
simultaneously recognizing product/service aspects and classifying sentiment for the collected data, using a single multi-task machine learning model via the processing circuitry,
wherein the product/service aspects are features and characteristics of a product or service that impact a sentiment class.

2. The method of claim 1, wherein the cyclically searching, via the processing circuitry, includes filtering out irrelevant content from the collected data and storing relevant content in a memory,
wherein the irrelevant content is content that does not mention the product or service.

3. The method of claim 1, wherein the refining the searching includes expanding search queries using the NLP model.

4. The method of claim 3, wherein the expanding search queries includes
extracting unique words from the collected data;
encoding user-entered aspects and the extracted unique words using the NLP model to obtain embedding vectors;
determining a plurality of similarity scores between pairs of the embedded vectors for the user-entered aspects and respective embedded vectors for the unique words;
sorting the pairs of embedded vectors by similarity score; and
selecting a top subset of the sorted pairs to build a new query.

5. The method of claim 1, wherein the simultaneously recognizing aspects and classifying sentiment using the single multi-task machine learning model includes sharing parameters of a base NLP model across multiple tasks.

6. The method of claim 5, wherein the recognizing aspects, as one of the multiple tasks, includes determining dependencies between aspect labels using a conditional random field layer.

7. The method of claim 5, wherein the classifying sentiment, as another of the multiple tasks, includes receiving a pooled output of the base NLP model and measures polarity of the pooled output.

8. The method of claim 1, further comprising:
ranking, via the processing circuitry, the products or services according to both product or service features and the aspects in addition to people's preferences calculated using a reputation score.

9. The method of claim 1, further comprising:
comparing, via the processing circuitry, a product or service with a peer product or service based on different product/service aspects, wherein respective aspects are determined using the multi-task machine learning model.

10. The method of claim 8, further comprising:
displaying the ranked products or services reputation in a dashboard.

11. A system for measuring reputation of products or services based on customer reviews and social media mentions, comprising:
processing circuitry configured with
a natural language processing (NLP) model for cyclically refining a search to collect data relating to the products or services; and
a single multi-task machine learning model for simultaneously recognizing product/service aspects and classifying sentiment for the collected data,
wherein the product/service aspects are features and characteristics of a product or service that impact a sentiment class.

12. The system of claim 11, wherein the processing circuitry is further configured to filter out irrelevant content from the collected data and store relevant content in a memory,
wherein the irrelevant content is content that does not mention the product or service.

13. The system of claim 11, wherein the processing circuitry is further configured to refine the search by expanding search queries.

14. The system of claim 13, wherein the expanding search queries includes
extracting unique words from the collected data;
encoding user-entered aspects and the extracted unique words using the NLP model to obtain embedding vectors;
determining a plurality of similarity scores between pairs of embedded vectors for the user-entered aspects and respective embedded vectors for the unique words;
sorting the pairs of embedded vectors by similarity score; and
selecting a top subset of the sorted pairs to build a new query.

15. The system of claim 11, wherein the single multi-task machine learning model simultaneously recognizes aspects and classifies sentiment by sharing parameters of a base NLP model across multiple tasks.

16. The system of claim 15, wherein the single multi-task machine learning model includes a conditional random field layer for determining dependencies between aspect labels.

17. The system of claim 15, wherein the classifying sentiment, as another of the multiple tasks, includes
receiving a pooled output of the base NLP model and measuring polarity of the pooled output.

18. The system of claim 11, wherein the processing circuitry is further configured to
rank the products or services according to both product or service features and the aspects in addition to people's preferences using a reputation score.

19. The system of claim 11, wherein the processing circuitry is further configured to
compare a product or service with a peer product or service based on different aspects, wherein respective aspects are determined using the multi-task machine learning model.

20. The system of claim 18, further comprising:
a display device for displaying the ranked products or services reputation in a dashboard.
